(19) United States
(12) Patent Application Publication
(10) Pub. No.: US 2011/0206328 A1
(43) Pub. Date: Aug. 25, 2011

(54) OPTOELECTRONIC MODULE WITH EMI SHIELD

(75) Inventor: William H. Wang, Pleasanton, CA (US)

(73) Assignee: EMCORE Corporation, Albuquerque, NM (US)

(21) Appl. No.: 12/712,979

(22) Filed: Feb. 25, 2010

(51) Int. Cl. G02B 6/36

(52) U.S. Cl. 385/94

(57) ABSTRACT

An optoelectronic module for converting and coupling an information-containing electrical signal with an optical fiber including a housing having an electrical input for coupling with an external electrical cable or information system device and for transmitting and receiving information-containing electrical signals over such input, and a fiber optic connector adapted for coupling with an external optical fiber for transmitting and receiving an optical signal; an electro-optical subassembly coupled to the information containing electrical signal and converting it to and/or from a modulated optical signal corresponding to the electrical signal; and an electromagnetic shield including (i) a latchable top cover; (ii) an O-ring metallic seal surrounding the optical ports; and (iii) a spring-clip finger shaped sleeve circumferentially surrounding the optical ports.

### REFERENCE TO RELATED APPLICATIONS

This application is related to U.S. Pat. No. 7,534,054.

This application is related to U.S. patent application Ser. No. 11/499,120.

This application is related to U.S. patent application Ser. No. 12/437,815.

This application is related to U.S. patent application Ser. No. 11/712,725.

### BACKGROUND

1. Field of the Invention

The invention relates to optical communications devices, such as transmitters, receivers, and transceivers used in high throughput fiber optic communications links in local and wide area networks and storage networks, and in particular to electromagnetic shielding of such devices.

2. Description of the Related Art

Communications networks have experienced dramatic growth in data transmission traffic in recent years due to worldwide Internet access, e-mail, and e-commerce. As Internet usage grows to include transmission of larger data files, including content such as full motion video on-demand (including HDTV), multi-channel high quality audio, online video conferencing, image transfer, and other broadband applications, the delivery of such data will place a greater demand on available bandwidth. The bulk of this traffic is already routed through the optical networking infrastructure used by local and long distance carriers, as well as Internet service providers. Since optical fiber offers substantially greater bandwidth capacity, is less error prone, and is easier to administer than conventional copper wire technologies, it is not surprising to see increased deployment of optical fiber in data centers, storage area networks, and enterprise computer networks for short range network unit to network unit interconnection.

Such increased deployment has created a demand for electrical and optical transceiver modules that enable data system units such as computers, storage units, routers, and similar devices to be optionally coupled by either ran electrical cable or an optical fiber to provide a high speed, short reach (less than 50 meters) data link within the data center.

A variety of optical transceiver modules are known in the art to provide such interconnection that include an optical transmit portion that converts an electrical signal into a modulated light beam that is coupled to a first optical fiber, and a receive portion that receives a second optical signal from a second optical fiber and converts it into an electrical signal. The electrical signals are transferred in both directions over electrical connectors that interface with the network unit using a standard electrical data link protocol.

The optical transmitter section includes one or more semiconductor lasers and an optical assembly to focus or direct the light from the lasers into an optical fiber, which in turn, is connected to a receptacle or connector on the transceiver to allow an external optical fiber to be connected thereto using a standard SC, FC or LC connector. The semiconductor lasers are typically packaged in a hermetically sealed can or similar housing in order to protect the laser from humidity or other harsh environmental conditions. The semiconductor laser chip is typically a distributed feedback (DFB) laser with dimensions a few hundred microns to a couple of millimeters wide and 100-500 microns thick. The package in which they are mounted typically includes a heat sink or spreader, and has several electrical leads coming out of the package to provide power and signal inputs to the laser chips. The electrical leads are then soldered to the circuit board in the optical transceiver. The optical receive section includes an optical assembly to focus or direct the light from the optical fiber onto a photodetector, which in turn, is connected to a transimpedance amplifier/limiter circuit on a circuit board. The photodetector or photodiode is typically packaged in a hermetically sealed package in order to protect it from harsh environmental conditions. The photodiodes are semiconductor chips that are typically a few hundred microns to a couple of millimeters wide and 100-500 microns thick. The package in which they are mounted is typically from three to six millimeters in diameter, and two to five millimeters tall and has several electrical leads coming out of the package. These electrical leads are then soldered to the circuit board containing the amplifier/limiter and other circuits for processing the electrical signal.

Optical transceiver modules are therefore packaged in a number of standard form factors which are “hot pluggable” into a rack mounted line card network unit or the chassis of the data system unit. Standard form factors set forth in Multiple Source Agreements provide standardized dimensions and input/output interfaces that allow devices from different manufacturers to be used interchangeably. Some of the most popular MSAs include XENPAK (see www.xenpak.org), X2 (see www.X2 msa.org), SFF (“small form factor”), SFP (“small form factor pluggable”), XFP (“10 Gigabit Small Form Factor Pluggable”, see www.XFPMSA.org), and the 300-pin module (see www.300pinmsa.org).

Customers and users of modules are interested in such miniaturized transceivers in order to increase the number of interconnections or port density associated with the network unit, such as, for example in rack mounted line cards, switch boxes, cabling patch panels, wiring closets, and computer I/O interfaces.

### SUMMARY

### 1. Objects of the Invention

It is an object of the present invention to provide an optoelectronic module in a small pluggable standardized form factor with an electromagnetic interference (EMI) shield that forms the top cover of the module.

It is also another object of the present invention to provide a module for use in an optical fiber transmission system with an O-ring electromagnetic shield surrounding the optical ports.

It is still another object of the present invention to provide an optical transceiver with a spring-clip finger shaped electromagnetic shield adjacent to the optical ports.

Some implementations may achieve fewer than all of the foregoing objects.

### 2. Features of the Invention

Briefly, and in general terms, the present invention provides an optical transceiver for converting and coupling an information-containing electrical signal with an optical fiber comprising a housing including an electrical connector with a plurality of electrical conductors for coupling with an external electrical cable or information system device and for transmitting and/or receiving an information-containing electrical signal having a data rate at least 5 Gigabits per second on each interface, and a fiber optic connector adapted for coupling with an external optical fiber for transmitting and/or receiving an optical communications signal having a data rate at least 5 Gigabits per second; at least one electro-optical subassembly in the housing for converting between an information-containing electrical signal and a modulated optical signal corresponding to the electrical signals; and an O-ring shaped deformable electromagnetic shield mounted adjacent to and surrounding the optical beam port of said electro-optical subassembly.

Additional objects, advantages, and novel features of the present invention will become apparent to those skilled in the art from this disclosure, including the following detailed description as well as by practice of the invention. While the invention is described below with reference to preferred embodiments, it should be understood that the invention is not limited thereto. Those of ordinary skill in the art having access to the teachings herein will recognize additional applications, modifications and embodiments in other fields, which are within the scope of the invention as disclosed and claimed herein and with respect to which the invention could be of utility.

Some implementations or embodiments may incorporate or implement fewer of the aspects or features noted in the foregoing summaries.

### BRIEF DESCRIPTION OF THE DRAWINGS

These and other features and advantages of this invention will be better understood and more fully appreciated by reference to the following detailed description when considered in conjunction with the accompanying drawings, wherein:

FIG. 1A is a perspective view of a transceiver module in accordance with one embodiment.

FIG. 1B is an enlarged view of a portion of FIG. 1A illustrating the latching portion of the cover.

FIG. 1C is an enlarged view of a portion of FIG. 1A illustrating the pivoting portion of the cover.

FIG. 2A is a schematic sectional view of a cover in a first position relative to a base according to one embodiment.

FIG. 2B is a schematic sectional view of the cover in a subsequent second position relative to the base according to one embodiment.

FIG. 2C is a schematic sectional view of the cover in a subsequent third position relative to the base according to one embodiment.

FIG. 3 is a perspective view of a transceiver module in accordance with one embodiment.

FIG. 4A is an enlarged front perspective view of an EMI shield according to one embodiment.

FIG. 4B is an enlarged rear perspective view of the EMI shield of FIG. 4A.

FIG. 5A is an enlarged view of the EMI shield from a different perspective depicting the fingers making contact with the gasket around the periphery of the optical ports.

FIG. 5B is a sectional view of the EMI shield depicted in FIG. 5A through the 5B-5B plane in that Figure.

FIG. 6A is a top perspective view of an optical transceiver with a cut-away view through the housing of the transceiver into the interior of the housing illustrating the transmitter and receiver assemblies according to one embodiment.

FIG. 6B is an enlarged view of a portion of FIG. 6A illustrating the EMI shield.

FIG. 7A is a sectional view of FIG. 3 cut along line 7A-7A illustrating the housing and the shield.

FIG. 7B is an enlarged view of a portion of FIG. 7A illustrating the positioning of the shield relative to the housing.

FIG. 8 is a sectional view of FIG. 3 cut along line 8-8.

FIG. 9 is a sectional view of FIG. 3 cut along line 9-9.

Additional objects, advantages, and novel features of the present invention will become apparent to those skilled in the art from this disclosure, including the following detailed description as well as by practice of the invention. While the invention is described below with reference to preferred embodiments, it should be understood that the invention is not limited thereto. Those of ordinary skill in the art having access to the teachings herein will recognize additional applications, modifications and embodiments in other fields, which are within the scope of the invention as disclosed and claimed herein and with respect to which the invention could be of utility.

### DETAILED DESCRIPTION

Details of the present invention will now be described including exemplary aspects and embodiments thereof. Referring to the drawings and the following description, like reference numbers are used to identify like or functionally similar elements, and are intended to illustrate major features of exemplary embodiments in a highly simplified diagrammatic manner. Moreover, the drawings are not intended to depict every feature of the actual embodiment nor the relative dimensions of the depicted elements, and are not drawn to scale.

The present invention relates generally to electromagnetic shielding components for optical communications modules such as transmitters, receivers, and transceivers used in high speed fiber optic communications systems.

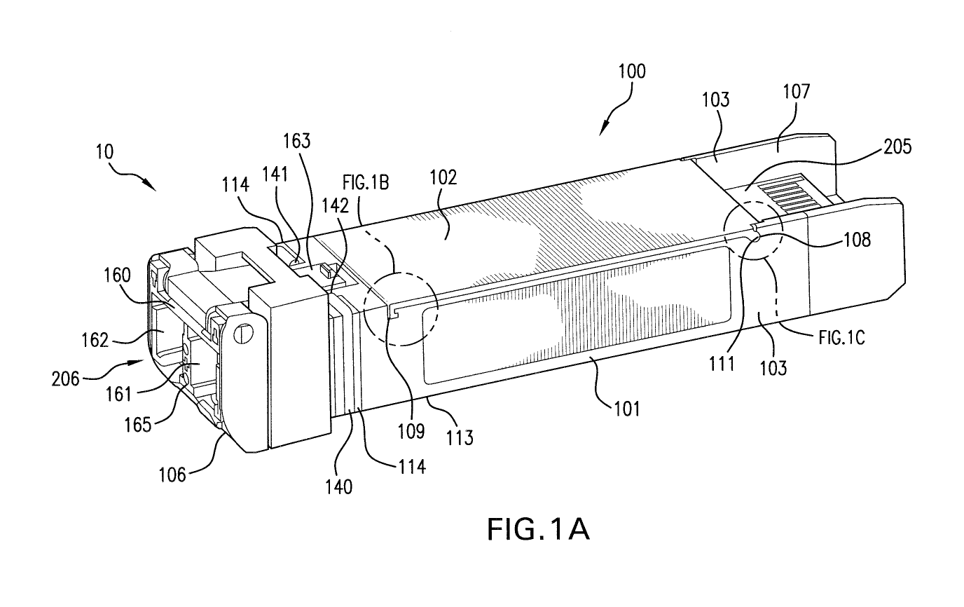

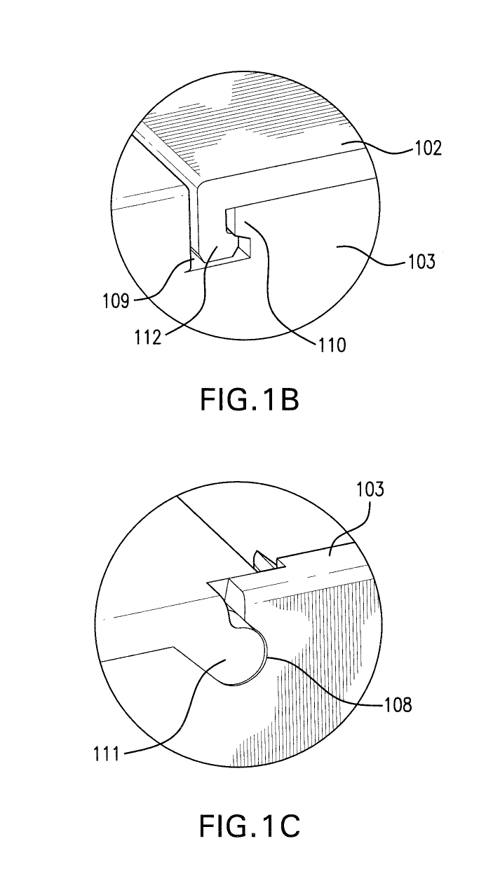

Referring now to FIG. 1, there is shown an exemplary pluggable optical transceiver module 10 according to a preferred embodiment of the present invention. The transceiver module 10 houses an electro-optical assembly 200, an electrical connector 205, and a fiber optic connector 206. In this particular embodiment, the module 10 is compliant with the IEEE 802.3ae 10GBASE-LR Physical Media Dependent sub-layer (PMD) and is implemented in the SFP+ form factor having a length of 56.5 mm, a width of 14 mm, and a height of 12 mm. It is to be noted, however, that in other embodiments the transceiver module 10 may be configured to operate under various other standard protocols (such as Fibre Channel or SONET) and be manufactured in various alternate form factors such as XENPAK, X2, etc. The module 10 is preferably a 10 Gigabit transceiver having a single 10 Gbps distributed feedback laser that enables three hundred meter transmission of an optical signal at least three hundred meters over a single legacy installed multimode fiber or a distance from 10 to 40 km over a single standard single mode fiber.

The transceiver module 10 includes a two-piece housing 100 including a base 101 and a cover 102. The base 101 includes side walls 103 and an intermediate wall 113. The base 101 has a rectangular cross-sectional shape with the two side walls 103 being relatively short, and a longer intermediate wall 113. The base 101 further includes a gap 104 opposite from the intermediate wall 103 that leads into an interior 105. The gap 104 may be positioned at the top or bottom of the housing 100. The base 101 further includes open opposing ends 106, 107 for the fiber optic connector 206 and the electrical connector 205 respectively.

The base 101 also includes a first cavity 108 towards the end 107 and a second cavity 109 towards the end 106 for receiving the cover 102. The first cavity 108 includes a rounded shape and extends into each of the side walls 103 at an angle away from the end 106 and the top edge of the side walls 103. The second cavity 109 includes a narrow neck and a wider bottom section, with the bottom section extending under a protrusion 110 in the side wall 103. In one embodiment, the second cavity 109 extends across the width of the base 101.

The cover 102 is removably connected to the base 101 and can pivot between open and closed orientations. The cover 102 includes an elongated shape sized to extend across the gap 104 and enclose the interior space 105. A first end of the cover 102 includes an enlarged connector 111 shaped to fit within the first cavity 108. The connector 111 may include two separate members positioned on the lateral edges of the cover 102 that fit into cavities 108 formed in each of the side walls 103. The sectional shape of the connector 111 may correspond to the first cavity 108, such as each having a circular shape as illustrated in the Figures. The corresponding circular shapes provide for pivoting the cover 102 between the open and closed orientations. A second end of the cover 102 includes a latch 112 that engages with the second cavity 109. The latch 112 includes a substantially L-shape with a narrow neck and an enlarged foot. This shape corresponds to the shape of the second cavity 109. The latch 112 may extend across the width of the cover 102.

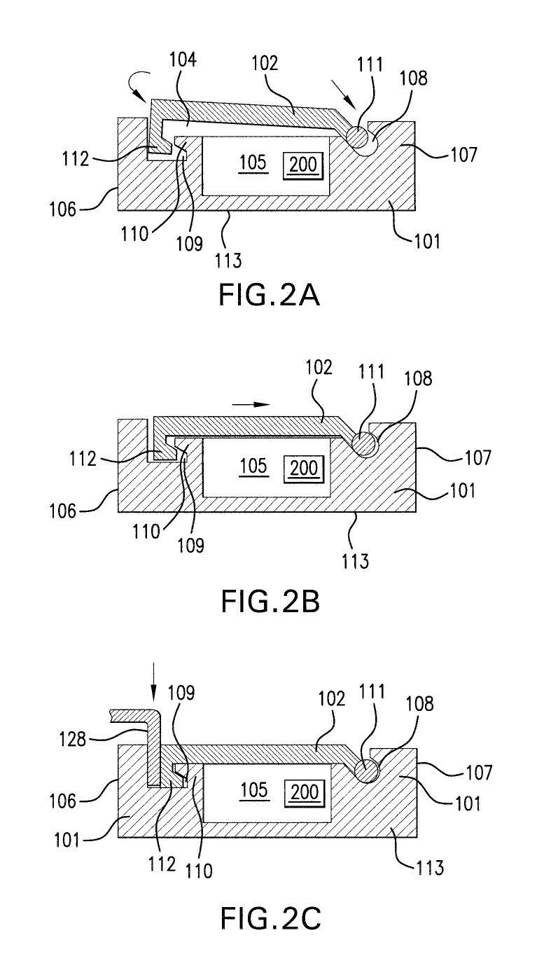

FIGS. 2A-2C illustrate the steps of connecting the cover 102 to the base 101. As illustrated in FIG. 2A, the cover 102 is initially inserted into the base 101 with the connector 111 on the first end of the cover 102 being partially inserted into the first cavity 108 and the latch 112 on the second end of the cover 102 being partially inserted into the second cavity 109. The latch 112 is inserted into the second cavity 109 an amount for the enlarged foot section to be positioned below the protrusion 110. As illustrated in FIG. 2B, the cover 102 is fully inserted into the base 101 and then slid in the direction indicated by the arrow. This sliding movement seats the connector 111 into the first cavity 108 and the latch 112 into the second cavity 109. As illustrated in FIG. 2C, an extension 128 is also positioned in the second cavity 109 to maintain the cover 102 attached to the base 101.

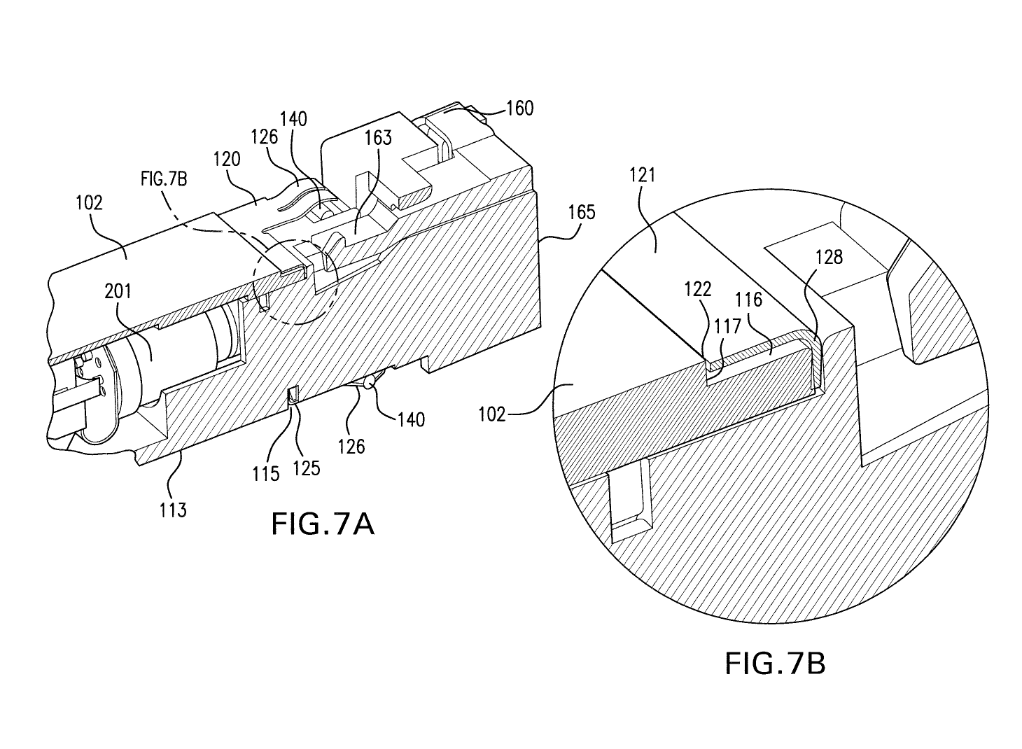

The cover 102 may also include a step 117 at the second end as illustrated in FIGS. 7A and 7B. The step 117 forms an abutment surface and a shelf 116 for a shield 120 as will be explained in detail below.

The housing 100, including the base 101 and the cover 102, may be constructed of die-case or milled metal, preferably die-cast zinc, although other materials also may be used, such as specialty plastics and the like. Preferably, the particular material used in the housing construction assists in reducing electromagnetic interference (EMI). The base 101 and cover 102 may be constructed from the same or different materials. The housing 100 may also include contact strips (not shown) to ground the module 10 to an external chassis ground as well.

The fiber optic connector 206 is positioned at the end 106 of the housing 100. The end 106 of the base 101 has a front 160. The front 160 includes a pair of receptacles 161, 162 separated by an intermediate wall 165 and configured to receive fiber optic connectors (not shown) which mate with ports 203, 204. In one embodiment, the connector receptacles 161, 162 are configured to receive industry standard LC duplex connectors. As such, keying channels are provided to ensure that the LC connectors are inserted into the receptacles 161, 162 in their correct orientation. Further, as shown in the exemplary embodiment, the connector receptacle 161 is intended for an LC receiver connector, and the connector receptacle 162 receives an LC transmitter connector.

The base 101 also includes a notch 114 in proximity to the end 106 as illustrated in FIG. 1A. The notch 114 may extend completely around the periphery of the base 101, or around a limited portion of the periphery. A gasket 140 is positioned within the notch 114 and provides an electromagnetic shield. The gasket 140 may include an annular shape and extend around the periphery of the base 101. The gasket 140 may extend completely around the periphery of the base 101, or a portion of the periphery and include spaced-apart ends 141, 142 that are separated by a gap. In one embodiment as illustrated in FIG. 1A, the gasket 140 extends around a portion of the periphery with the ends 141, 142 positioned on opposing sides of a clip 163. The gasket 140 may be constructed from a variety of materials, including but not limited to engineering plastics, fabric, metal, and wire mesh. In one embodiment, the gasket 140 is constructed from a deformable material and includes a metalized outer surface. The gasket 140 may be constructed from one or more materials, or may include different inner and outer materials. In one embodiment, gasket 140 includes a metalized outer surface that extends over a different interior material. The gasket 140 may include a variety of sectional shapes, including circular, oval, and polygonal.

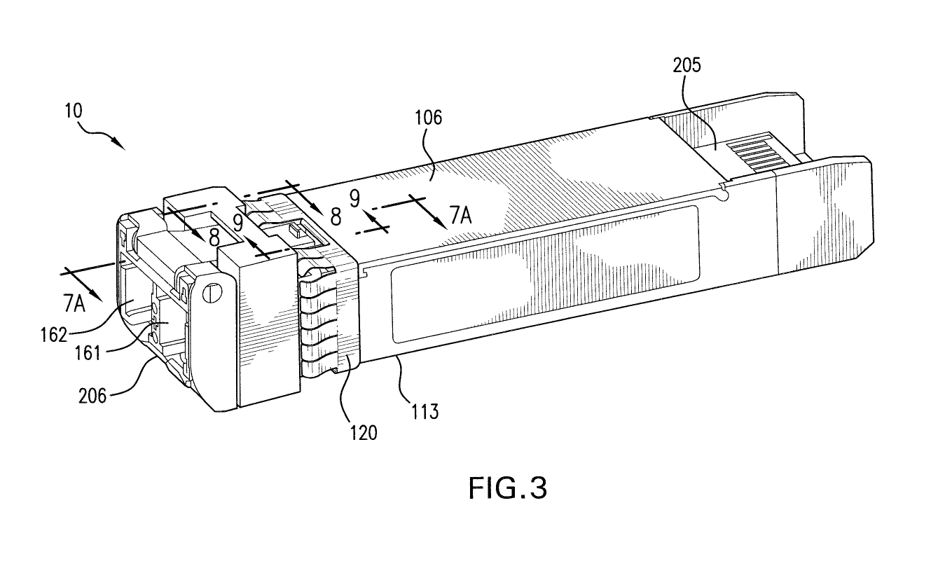

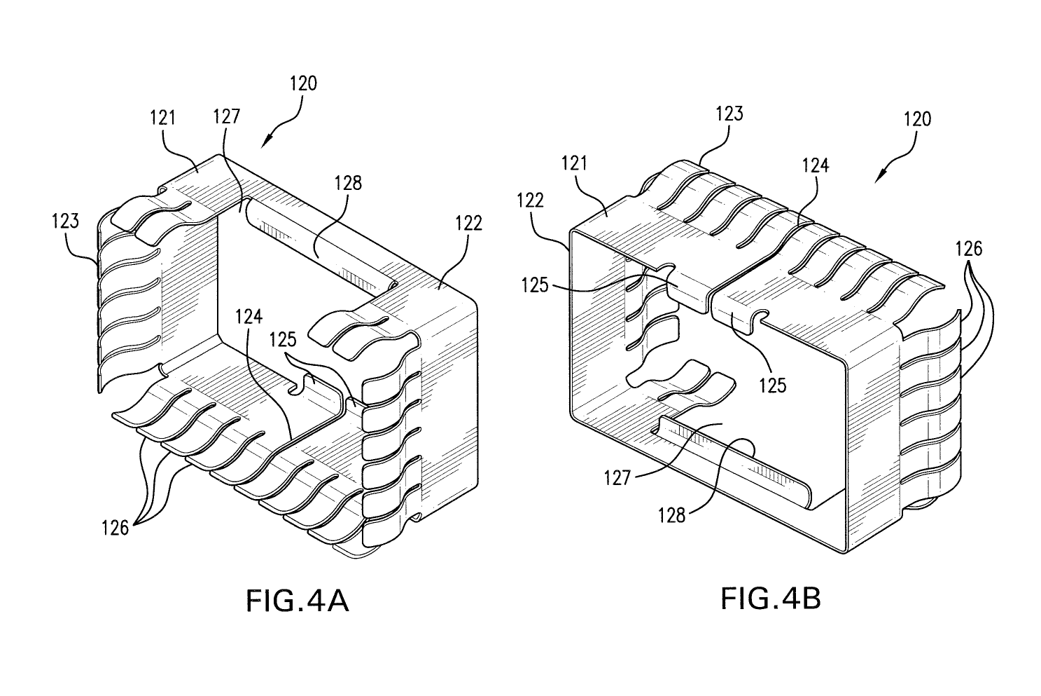

An electromagnetic shield 120 may extend over the gasket 140 and the base 101 at a point towards the end 106 as illustrated in FIG. 3. The shield 120 is illustrated in FIGS. 4A and 4B and includes an annular shape with a first end 122 formed by a sleeve 121 and a second end 123 with fingers 126 positioned around a portion of the periphery. The sleeve 121 includes a generally rectangular shape with a central opening that corresponds to the housing 100. A slot 124 extends through the sleeve 121 and between the fingers 126 to adjust a size of the shield 120. The sleeve 121 includes one or more extensions 125 that extend radially inward into the central opening. Another extension 128 extends radially inward into the central opening from an opposing side of the sleeve 121 from the extensions 125. The extension 128 fit within the second cavity 109 to maintain the cover 102 in the closed orientation as illustrated in FIG. 2C.

The fingers 126 are spaced around a majority of the periphery of the shield 120. The fingers 126 do not extend around the shield 120 adjacent to the extension 128. The fingers 126 include a curved shape with a concave portion that faces inward towards the central opening and towards the housing 100 when the shield 120 is connected to the housing 100. The concave portion is sized to receive the gasket 140 and contact against the outer surface of the gasket 140.

The shield 120 is constructed of a relatively thin material. The fingers 126 each include a relatively narrow width that allows for radial flexing. The shield 120 may be constructed from a variety of materials, including but not limited to stainless steel, phosphor bronze, and beryllium copper.

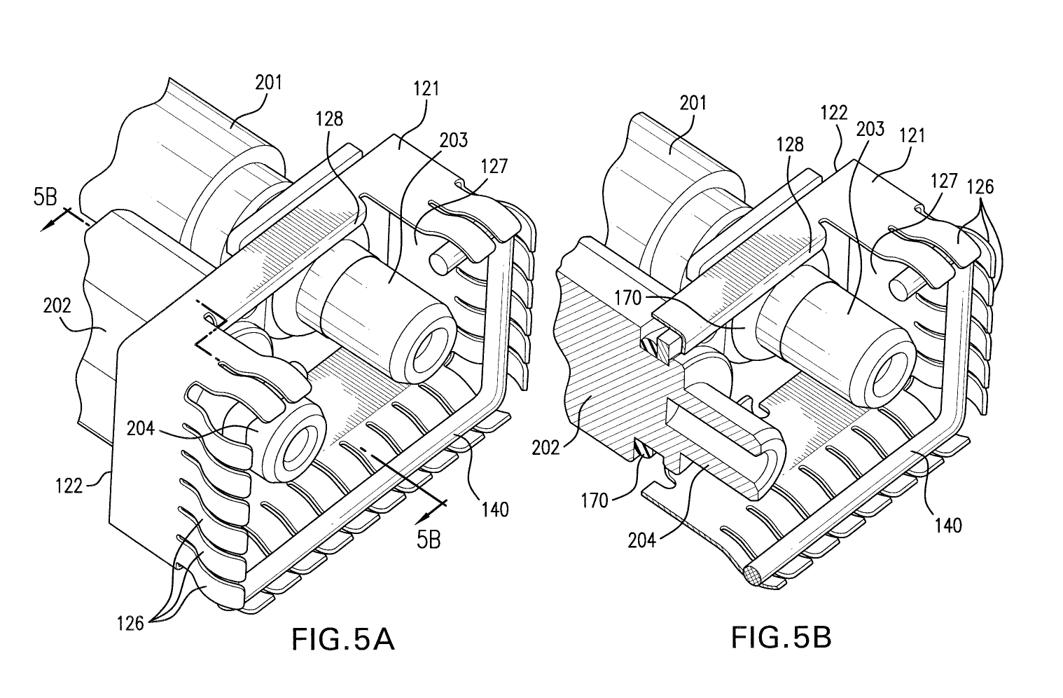

FIGS. 5A and 5B illustrate the shield 120 and gasket 140 positioned around ports 203, 204 of a transmitter assembly 201 and receiver assembly 202 respectively. The ports 203, 204 are aligned with the receptacles 161, 162 respectively (see FIG. 1A). For purposes of clarity, the housing 100 is not illustrated in FIG. 5A or 5B.

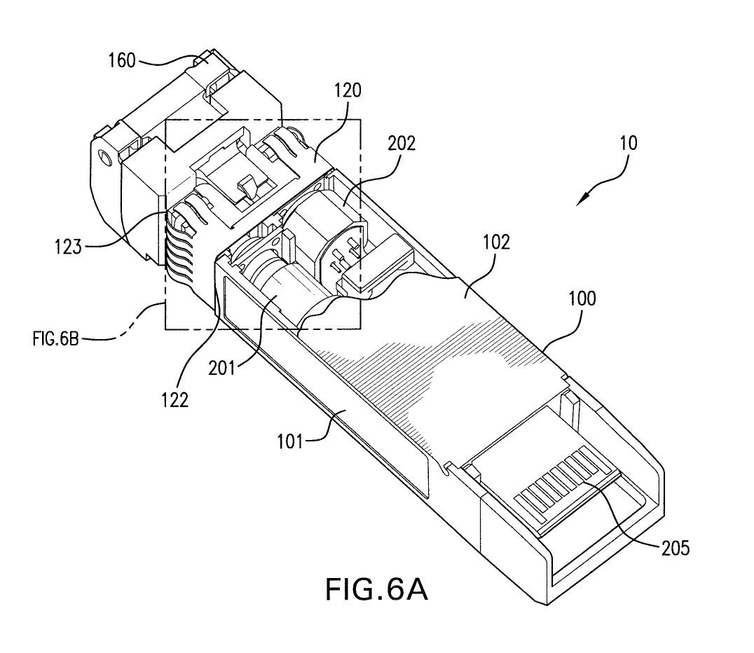

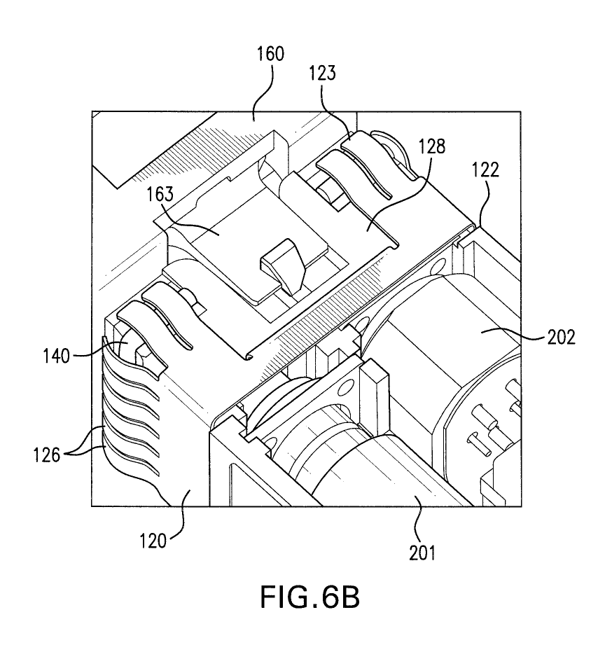

FIGS. 6A and 6B illustrate the shield 120 positioned on the housing 100. The shield 120 provides an electromagnetic shield for the components of the transceiver module 10. The fingers 126 extend over the base 101 and the gasket 140. The relatively sizing between these elements may cause the fingers 126 to be biased radially outward such that they apply a compressive force against the housing 101 and gasket 140 to maintain an effective attachment. The base 101 may further include a clip 163 that fits within the cutout 127 in the shield 120.

The housing 100 may also include features to accommodate the shield 120. As illustrated in FIGS. 7A and 7B, the intermediate wall 113 of the housing may include a notch 115 that receives the extensions 125 that extend outward from the sleeve 121 of the shield 120. The cover 102 may also include the step 117 that forms the shelf 116 that receives the sleeve 121 of the shield 120. The step 117 also forms an abutment surface that contacts against the end 122 of the shield 102.

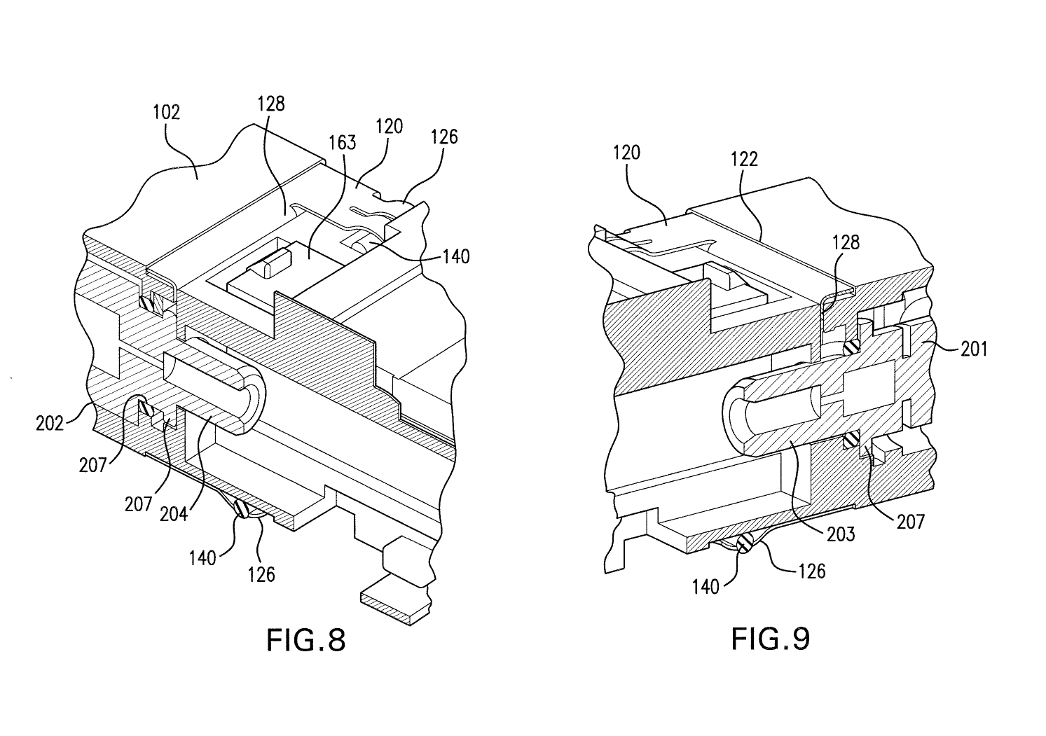

O-rings 170 may be positioned on the electro-optical assembly 200 to provide a further EMI shield. The O-rings 170 include an annular shape with an enclosed central region that extends around one of the ports 203, 204 as illustrated in FIGS. 5A, 5B, 8, and 9. The O-rings 170 may be constructed of an elastic material and have various shapes. Further, the O-rings 170 may include various sectional shapes. In one embodiment, the O-rings 170 include circular shapes and sectional shapes. The O-rings 170 may be constructed from the same materials as the gasket 140 described above.

The O-rings 170 are positioned along the ports 203, 204 of the transmitter and receiver assemblies 201, 202. The O-rings 170 are positioned with an inner side contacting against one of the ports 203, 204, and the outer side contacting against the housing 100. The ports 203, 204 may include flanges 207 that form corners that are contacted by the O-rings 170. Embodiments may include a single O-ring 170 positioned along the ports 203, 204, with other embodiments featuring multiple O-rings 170 positioned along one or both ports 203, 204.

In one embodiment, the electro-optical assembly 200 holds three subassemblies or circuit boards, including a transmit board, a receive board, and a physical coding sublayer/physical medium attachment board, which is used to provide an electrical interface to external computer or communications units (not shown). Aspects of the electro-optical assembly 200 are disclosed in U.S. Pat. No. 7,534,054, and U.S. patent application Ser. Nos. 11/499,120, 12/437,815, and 11/712,725 each of which is incorporated herein in their entireties.

One embodiment is the use of the housing 100 and shielding aspects in a pluggable 10 Gigabit transceiver. The same principles are applicable in other types of optical transceivers suitable for operating over both multimode (MM) and single mode (SM) fiber using single or multiple laser light sources, single or multiple photodetectors, and an appropriate optical multiplexing and demultiplexing system. The designs are also applicable to a single transmitter or receiver module, or a module as either a transmitter, receiver, or transceiver to communicate over different optical networks using multiple protocols and satisfying a variety of different range and distance goals.

While the invention has been illustrated and described as embodied in a transceiver for an optical communications network, it is not intended to be limited to the details shown, since various modifications and structural changes may be made without departing in any way from the spirit of the present invention.

While particular embodiments of the present invention have been shown and described, it will be understood by those skilled in the art that, based upon the teachings herein, changes and modifications may be made without departing from this invention and its broader aspects and, therefore, the appended claims are to encompass within their scope all such changes and modifications as are within the scope of this invention. Furthermore, it is to be understood that the invention is solely defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” “comprise” and variations thereof, such as, “comprises” and “comprising” are to be construed in an open, inclusive sense, that is as “including, but not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

What is claimed is:

1. An optical transceiver for converting and coupling an information-containing electrical signal with an optical fiber comprising:
a housing including an electrical connector with a plurality of electrical conductors for coupling with an external electrical cable or information system device and for transmitting and/or receiving an information-containing electrical signal having a data rate at least 5 Gigabits per second on each interface, and a fiber optic connector adapted for coupling with an external optical fiber for transmitting and/or receiving an optical communications signal having a data rate at least 5 Gigabits per second;
at least one electro-optical subassembly in the housing for converting between an information-containing electrical signal and a modulated optical signal corresponding to the electrical signals; and
an O-ring shaped deformable electromagnetic shield mounted adjacent to and surrounding an optical beam port of said electro-optical subassembly.

2. An optical transceiver as defined in claim 1,
wherein the O-ring shield has a metalized outer surface.

3. An optical transceiver as defined in claim 1,
wherein one portion of the O-ring shield makes contact with the optical beam port, and another portion of the O-ring shield makes contact with the housing.

4. An optical transceiver as defined in claim 1,
wherein the O-ring shield is disposed against a flange corner of the optical beam port.

5. An optical transceiver as defined in claim 1,
wherein the optical beam port is metallic.

6. An optical transceiver as defined in claim 1,
further comprising a second O-ring shield mounted to and extending around a second port of the electro-optical subassembly.

7. An optical transceiver as defined in claim 1,
further comprising a sleeve-shaped electromagnetic shield that extends over a section of the housing, the sleeve-shaped electromagnetic shield including a sleeve portion at a first end and a plurality of flexible fingers at a second end.

8. An optical transceiver as defined in claim 7,
wherein the housing comprises a base and a removable cover, the sleeve-shaped electromagnetic shield extending over the section of the housing and contacting against the cover to maintain the cover connected to the base.

9. An optical transceiver as defined in claim 1,
wherein the housing has an SFP+ form factor with a length of 56.5 mm, a width of 14 mm, and a height of 12 mm.

10. An optical transceiver for converting and coupling an information-containing electrical signal with an optical fiber comprising:
a generally rectangularly shaped housing including an electrical connector with a plurality of electrical conductors for coupling with an external electrical cable or information system device and for transmitting and/or receiving an information-containing electrical signal having a data rate at least 5 Gigabits per second on each interface, and a fiber optic connector adapted for coupling with an external optical fiber for transmitting and/or receiving an optical communications signal having a data rate at least 5 Gigabits per second;
at least one electro-optical subassembly in the housing for converting between an information-containing electrical signal and a modulated optical signal corresponding to the electrical signals and coupled to the fiber optic connector; and
a circumferential EMI shield composed of a metallic sheet material mounted on the housing adjacent to said fiber optic connector, said shield including a first portion including a sleeve for engaging the shield with the four sides of the rectangularly shaped housing, and a second portion including a plurality of spring-clip fingers extending around at least a portion of the circumference of the EMI shield, each finger having a substantially concave portion facing the housing and engaging the surface of an electrically conductive convex member circumferentially surrounding at least a portion of the periphery of the housing.

11. An optical transceiver as defined in claim 10, further comprising:
a generally rectangularly shaped top cover for mounting over the housing, the cover having a lip extending along at least a portion of the width of the shorter side of the cover for engaging with a latch on the housing so as to detachably secure the top cover to the housing.

12. An optical transceiver as defined in claim 11,
wherein the top cover further includes a cylindrically shaped edge extending over at least a portion of a shorter side of the cover for rotatably engaging with a recessed cylindrical cavity on the housing to permit the top cover to pivot.

13. An optical transceiver as defined in claim 11,
wherein a portion of the circumferential EMI shield engages with the lip portion of the top cover so as to lock the lip position of the top cover against the latch.

14. An optical transceiver as defined in claim 10,
wherein the electrically conductive convex member has a metalized outer surface.

15. An optical transceiver as defined in claim 10,
wherein the housing has an SFP+ form factor with a length of 56.5 mm, a width of 14 mm, and a height of 12 mm.

16. An optical transceiver for converting and coupling an information-containing electrical signal with an optical fiber comprising:
a generally rectangularly shaped housing;
an electrical connector positioned in the housing with a plurality of electrical conductors for coupling with an external electrical cable or information system device and for transmitting and/or receiving an information-containing electrical signal;
a fiber optic connector positioned in the housing adapted for coupling with an external optical fiber for transmitting and/or receiving an optical communications signal having a data rate at least 5 Gigabits per second;
at least one electro-optical subassembly in the housing for converting between an information-containing electrical signal and a modulated optical signal corresponding to the electrical signals and coupled to the fiber optic connector, the electro-optical subassembly including a transmitter assembly and a receiver assembly; and
a circumferential EMI shield composed of a metallic sheet material mounted on the housing adjacent to said fiber optic connector, said shield including a first portion including a sleeve for engaging the shield with the four sides of the rectangularly shaped housing, and a second portion including a plurality of spring-clip fingers;
an electrically conductive gasket mounted on the housing and having an inner surface that contacts the housing and an outer surface that contacts against the plurality of spring-clip fingers;
a first O-ring electromagnetic shield extending around the transmitter assembly; and
a second O-ring electromagnetic shield extending around the receiver assembly.

17. An optical transceiver as defined in claim 16,
wherein each of the plurality of spring-clip fingers has a substantially concave portion facing the housing and contacting against the electrically conductive convex member.

18. An optical transceiver as defined in claim 16,
wherein the housing includes a base and a cover, the cover having a lip extending along at least a portion of the width of the shorter side of the cover for engaging with a latch on the base so as to detachably secure the top cover to the base.

19. An optical transceiver as defined in claim 18,
wherein the cover further includes a cylindrically shaped edge extending over at least a portion of a shorter side of the cover for rotatably engaging with a recessed cylindrical cavity on the base to permit the cover to pivot.

20. An optical transceiver as defined in claim 19,
wherein a portion of the circumferential EMI shield engages with the cover to lock the lip of the top cover against the latch.
